(19) United States
(12) Patent Application Publication
(10) Pub. No.: US 2025/0261630 A1
(43) Pub. Date: Aug. 21, 2025

(54) Multiple Game Calling Device

(71) Applicant: Ricky Joe Bishop, Warm Springs, GA (US)

(72) Inventor: Ricky Joe Bishop, Warm Springs, GA (US)

(21) Appl. No.: 18/920,169

(22) Filed: Oct. 18, 2024

Related U.S. Application Data
(60) Provisional application No. 63/554,058, filed on Feb. 15, 2024.

(51) Int. Cl. A01M 31/00

(52) U.S. Cl. CPC A01M 31/004

(57) ABSTRACT

A multiple game calling device includes a plurality of game call structures each configured to enable making a distinct sound for eliciting a response from a distinct predetermined animal, wherein the game call structures are interconnected. The device includes a case for carrying one or more a diaphragm-type game call to enable making a sound for eliciting a response from a distinct predetermined animal.

### FIELD OF THE INVENTION

The present invention relates to wildlife or animal calls of the type that produce sounds emulating that of wildlife.

### BACKGROUND OF THE INVENTION

Wildlife or animal calls have been in use for a long time, particularly by hunters. A hunter or operator uses the call to make sounds like an animal makes. For example, in the case of luring out a desired targeted animal, the hunter might use a call which tends to cause the targeted animal to move, for example and owl or crow or may produce a call to attract a particular target, or another call for a turkey, or deer, sounds that emulate a buck or a doe. To attract coyotes, or other predators, a hunter may produce sounds that emulate a rabbit in distress. To attract ducks, a hunter may use a duck call.

Traditionally, wildlife calls have been manually generated, such as by blowing one's breath across a reed or vibrating membrane or by scratching a plate surface or vibrating a box. Such calls take experience to operate successfully and are limited to making only a small number of specific sounds, say for ducks or turkey.

It is not uncommon for hunters to carry multiple calls on their person, typically in a vest while hunting. However, it is often a problem to find the particular call type when spotting a desired target while hunting. It is therefore desirable to be able to have these calls available in a single device. These calls are often in a vest worn by the hunter in several pockets of the vest. Thus, it can be difficult to find the one desired.

There remains a need to provide a device which overcomes these problems. It is desired to simplify the use of call devices and to improve on such devices.

### SUMMARY OF THE INVENTION

It is an object to improve hunting experience.

A further object is to aid a hunter with a multiple call device.

Still another object is to incorporate a multiple call device as part of a case.

Accordingly, the invention is directed to a multiple game calling device which includes a first game call structure configured to enable making a sound for eliciting a response from a first predetermined animal, a second game call structure configured to enable making a sound for eliciting a response from a second predetermined animal, a third game call structure configured to enable making a sound for eliciting a response from a third predetermined animal and preferably a case for carrying one or more a diaphragm-type game call to enable making a sound for eliciting a response from a fourth predetermined animal. The game call structures are interconnected to form a unit.

The case provided removably connects to at least one of the game call structures. In a preferred embodiment, the case includes either a metal or magnet and one of the game call structures includes either a respective magnet or metal structure to enable the removal.

In a preferred embodiment, the second call structure interconnects the first and third call structure. In a preferred embodiment, the second call structure is characterized to be a turkey call and includes a friction surface, a striker retaining surface and a striker removably retained in the striker retaining surface and a turkey call can be delivered by removing the striker and striking the friction surface. The first call structure can be configured for delivering an owl sound. The third call structure can be configured for delivering a crow sound. Other call configurations are envisioned.

### BRIEF DESCRIPTION OF THE DRAWINGS

FIG. 1 is a first perspective view of the invention in exploded form.

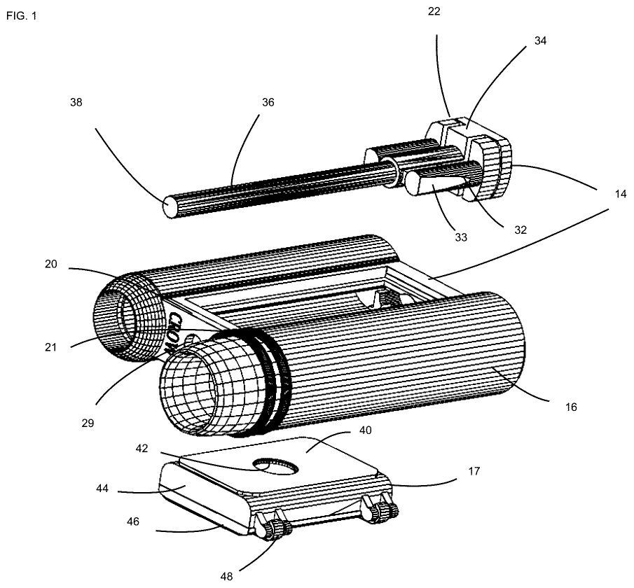

FIG. 2 is a second perspective view of the invention in exploded form.

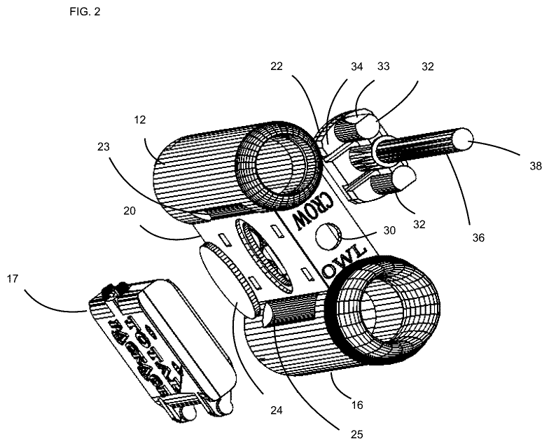

FIG. 3 is a third perspective view of the invention in exploded form.

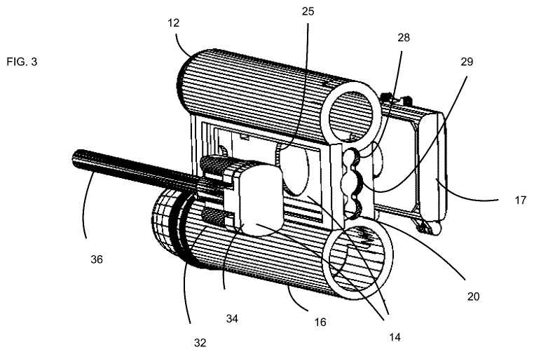

FIG. 4 is a fourth perspective view of the invention in exploded form.

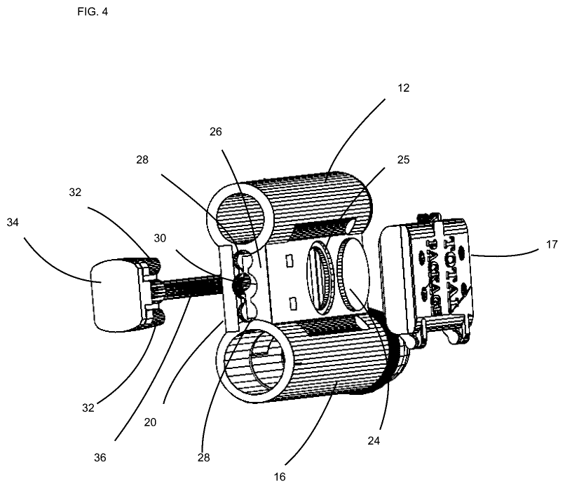

FIG. 5 is an end perspective view of the invention in exploded form.

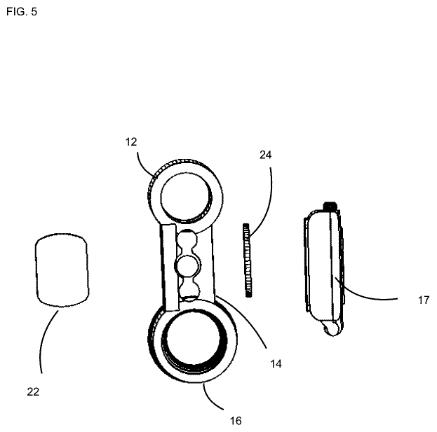

FIG. 6 is another end perspective view of the invention in exploded form.

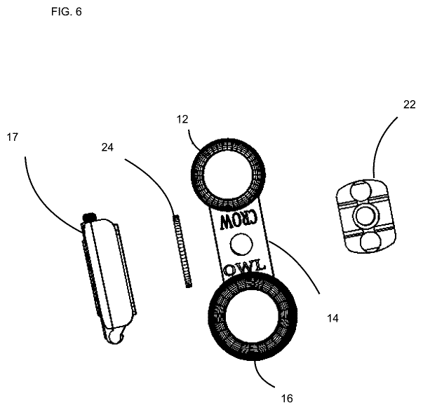

FIG. 7 is yet another end perspective view of the invention in exploded form.

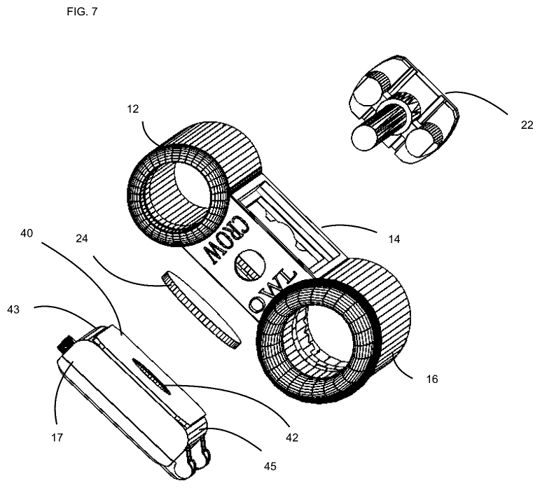

FIG. 8 is a fifth perspective view of the invention in exploded form.

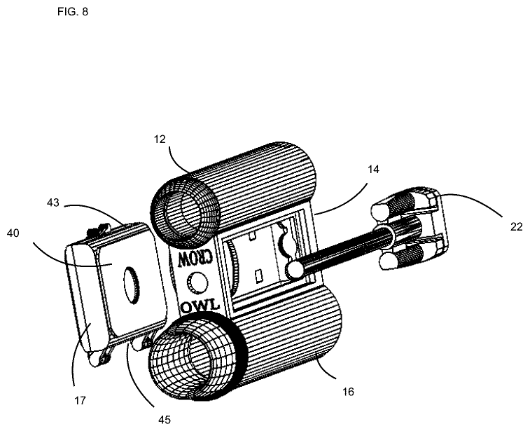

FIG. 9 is a side perspective view of the invention in exploded form.

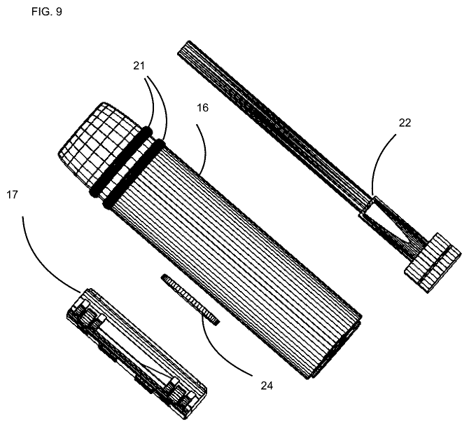

FIG. 10 is a perspective view of one side of a part of the invention.

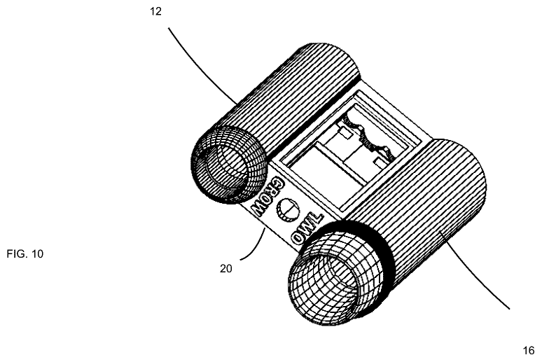

FIG. 11 is a perspective view of another side of a part of the invention.

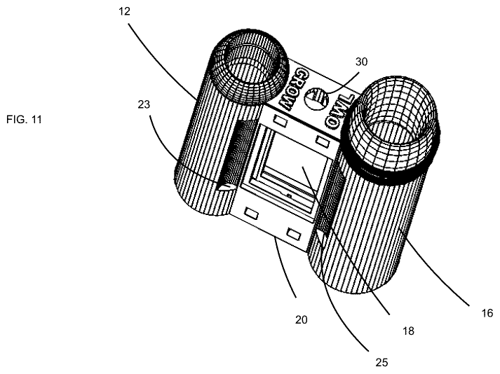

FIG. 12 is a plan view of side of the part in FIG. 10.

FIG. 13 is a plan view of side of the part in FIG. 11.

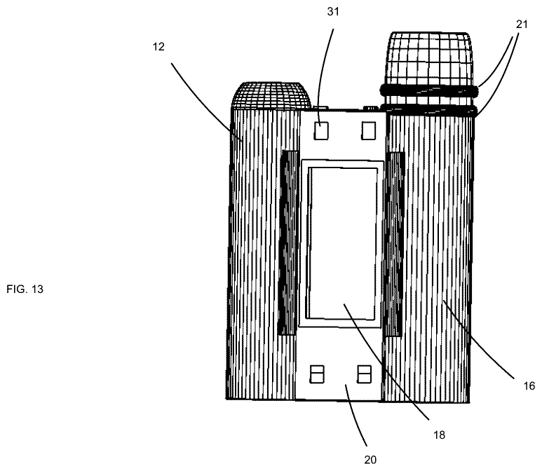

FIG. 14 is an end view of the part in FIG. 10.

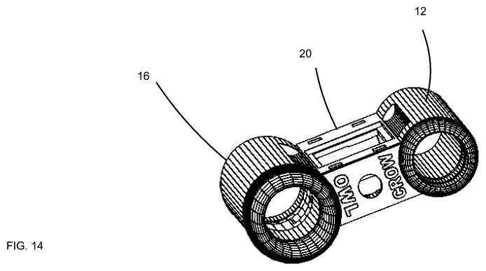

FIG. 15 is a sixth perspective view of the invention in exploded form.

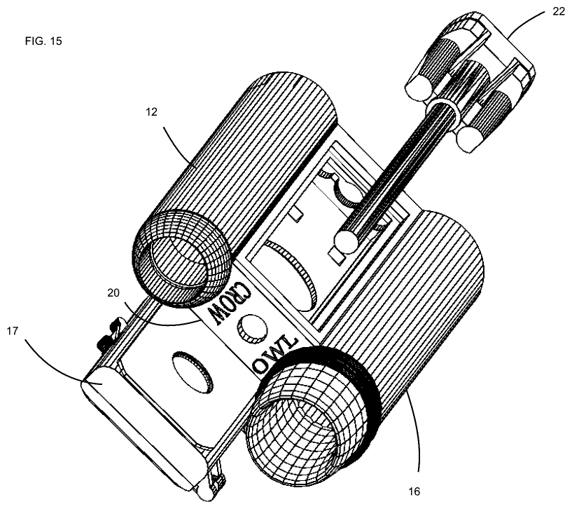

### DETAILED DESCRIPTION OF THE PREFERRED EMBODIMENT

Referring now to the drawings, a multiple game calling device is generally designated by the numeral 10. The multiple game calling device 10 includes a first game call structure 12 configured to enable making a sound for eliciting a response from a first predetermined animal, a second game call structure 14 configured to enable making a sound for eliciting a response from a second predetermined animal, a third game call structure 16 configured to enable making a sound for eliciting a response from a third predetermined animal and preferably a case 17 for carrying one or more a diaphragm-type game call to enable making a sound for eliciting a response from a fourth predetermined animal. The game call structures 12, 14, 16 and case 17 are interconnected to form a unit.

In a preferred embodiment, the second call structure 14 interconnects the first call structure 12, third call structure 16 and case 17. In a preferred embodiment, the second call structure 14 is characterized to be a turkey call and includes a friction surface 18 which is part of an interconnecting member 20 which connects the first and third call structures 12 and 16 and a striker 22. The interconnecting member 20 can be a rigid panel having the friction surface 18 incorporated therein which can be made of various friction materials such as wood, anodized aluminum, copper to name a few. The interconnecting member 20 can also include either a part 24 which can be magnet or metallic structure for connecting a magnet thereto. Here, there is formed a receiving surface 25 for the part 24.

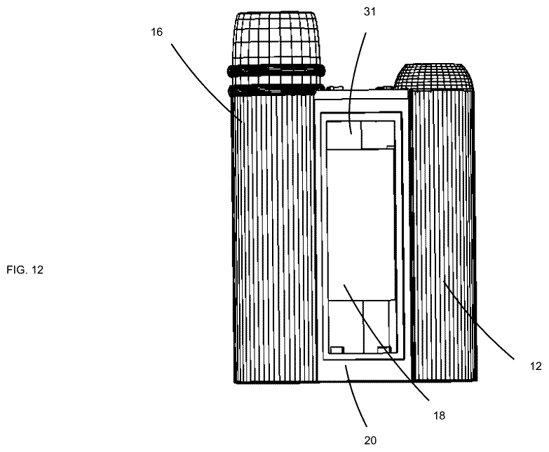

An end 26 of the interconnecting member 20 includes a striker receiving surfaces 28, 29 and 30 where in the exemplary embodiment receiving surfaces 28 frictionally retain side supports 32 which extend from a handle 34 and flank a central strike member 36 which extends from the handle 34 and is removably received through receiving surfaces 29 and 30. The interconnecting member 20 can also include openings 31 in order to increase the sound effect achievable when using the striker 22. Additionally as seen in FIG. 12, the friction surface 18 can include various surface types which can be interconnected as part of the surface 18. Side supports 32 are formed with a tapered surface 33 which serve as a wedge and when pushed into receiving surfaces 28 aid in frictionally retention of the striker 22 as the diameter of the side supports 32 increase as the supports 32 extend into the retention surfaces 28.

The striker 22 which is removably retained in the striker receiving surfaces 28, 29 and 30 and can be removed and while holding the handle 34, an end 38 can be moved across the friction surface 18 to create a turkey call, for example. The central strike member 36 can be made of different materials. In a preferred embodiment, the first call structure 12 can be configured for delivering a crow sound. The third call structure 16 can be configured for delivering an owl sound. These are simply exemplary but other calls are possible. Here, the first call structure 12 and the third call structure 16 are longer in length than the second call structure 14, where the third call structure 16 can include a pair of radially extending ribs 21 about the call structure 16 and are spaced from one another so that they serve as a retention area for a lanyard cord (not shown) which a user can optionally employ. It is contemplated that the first call structure 12 could alternatively have this feature. Also, first call structure 12 and the third call structure 16 have case receiving surface areas 23 and 25, respectively, for receiving edges 43 and 45 of housing 44.

The case 17 provided is shown here to removably connect to the second game call structure 14. The case 17 includes either includes a complementary part 40, such as a metal or magnet, and thus is removably connectable to the interconnecting member 20. The case 17 includes housing 44 and a cover 46 which is hingedly connected by hinges 48. An open surface 42 is provided for receiving metal, magnet, or another material for use with the device 10.

By so providing, the instant invention sets forth a unique device that allows for carrying several different types of wild game calls in a single, lightweight, compact, manageable unit for hunting purposes. Under normal circumstances, a hunter can store the device 10 on his/her person or conveniently in a pocket hunting vest in which he stores and now is enabled with a variety of wild game calls. This unit combines different types of game calls, namely an owl call, a crow call, a friction-type turkey call, and a diaphragm-type game call, in one single carrying device. This makes it more comfortable, less cumbersome, and much more effective for the hunter to access any of the needed calls during a hunt.

While the instant invention has been set forth the above in a detailed description and embodiment, it is envisioned that other modifications, derivations and improvements will be readily apparent to those skilled in the art. For example, other call structure are envisioned for making other calls for other animals. Accordingly, the appended claims should be afforded a scope which covers such improvements, derivations, and modifications.

1. A multiple game calling device, which includes:
a first game call structure configured to enable making a sound for eliciting a response from a first predetermined animal;
a second game call structure configured to enable making a sound for eliciting a response from a second predetermined animal different than said first predetermined animal; and
a third game call structure configured to enable making a sound for eliciting a response from a third predetermined animal different than said first predetermined animal and said second predetermined animal, wherein said game call structures are interconnected.

2. The multiple game calling device of claim 1, which further includes a case for carrying at least one diaphragm-type game call to enable making a sound for eliciting a response from a fourth predetermined animal different than said first predetermined animal, said second predetermined animal, and said third said predetermined animal, said case connected to at least one of said first game call structure, said second game call structure, and said third game call structure.

3. The multiple game calling device of claim 2, wherein said case is removably connected to at least one of said first game call structure, said second game call structure, and said third game call structure.

4. The multiple game calling device of claim 3, wherein said case includes one of a metal and magnet and said at least one of said game call structures includes one of a complementary magnet and metal.

5. The multiple game calling device of claim 1, wherein said second call structure includes a friction surface, a striker retaining surface and a striker removably retained in said striker retaining surface.

6. The multiple game calling device of claim 1, wherein at least one of said first game call structure, said second game call structure, and said third game call structure includes a radially extending rib structure for receiving a lanyard.

7. A multiple game calling device, which includes:
a first game call structure configured to enable making a sound for eliciting a response from a first predetermined animal; and
a case connected to said first game call structure for carrying at least one diaphragm-type game call to enable making a sound for eliciting a response from a second predetermined animal different from said first predetermined animal.

8. The multiple game calling device of claim 7, which further includes a third game call structure connected to said first game call structure and configured to enable making a sound for eliciting a response from a third predetermined animal different from said first predetermined animal and said second predetermined animal.

9. The multiple game calling device of claim 8, which includes a fourth game call structure connected to one of said first game call structure and said third game call structure and configured to enable making a sound for eliciting a response from a fourth predetermined animal different from said first predetermined animal, said second predetermined animal and said third predetermined animal.

10. The multiple game calling device of claim 7, wherein said case is removably connected to said first game call structure.

11. The multiple game calling device of claim 7, wherein said case includes one of a metal and magnet and said first game call structure includes one of a complementary magnet and metal.

12. A multiple game calling device, which includes a plurality of game call structures wherein each game call structure is configured to enable making a distinct sound for eliciting a response from a distinct predetermined animal, wherein said game call structures are interconnected.

13. The multiple game calling device of claim 12, which includes a case connected to at least one of said game call structures for carrying at least one a diaphragm-type game call to enable making a sound for eliciting a response from another distinct predetermined animal.

14. The multiple game calling device of claim 12, wherein at least one of said game call structures includes a lanyard retaining surface.
